(19) United States
(12) Patent Application Publication
(10) Pub. No.: US 2012/0072442 A1
(43) Pub. Date: Mar. 22, 2012

(54) MONADIC TYPE PRESERVATION FOR QUERY OPERATORS

(75) Inventors: Bart De Smet, Bellevue, WA (US); Henricus Johannes Maria Meijer, Mercer Island, WA (US); Jeffrey Van Gogh, Redmond, WA (US); John Wesley Dyer, Monroe, WA (US)

(73) Assignee: MICROSOFT CORPORATION, Redmond, WA (US)

(21) Appl. No.: 12/887,588

(22) Filed: Sep. 22, 2010

(51) Int. Cl. G06F 17/30

(52) U.S. Cl. 707/769; 707/E17.069

(57) ABSTRACT

Monadic types are preserved for query operators to further query operator compositionality utilizing operators defined over a monad. Query operators that are defined over a monad and are suited to return non-monadic types are constructed or altered to return a monadic type. For instance, aggregate query operators defined over a local or remote sequence monad can be generated that return a monadic type.

### BACKGROUND

Data processing is a fundamental part of computer programming. One can choose from amongst a variety of programming languages with which to author programs. The selected language for a particular application may depend on the application context, a developer's preference, or a company policy, among other factors. Regardless of the selected language, a developer will ultimately have to deal with data, namely querying and updating data.

A technology called language-integrated queries (LINQ) was developed to facilitate data interaction from within programming languages. LINQ provides a convenient and declarative shorthand query syntax to enable specification of queries within a programming language (e.g., C#®, Visual Basic® . . . ). More specifically, query operators are provided that map to lower-level language constructs or primitives such as methods and lambda expressions. Query operators are provided for various families of operations (e.g., filtering, projection, joining, grouping, ordering . . . ), and can include but are not limited to “where” and “select” operators, wherein these names or identifiers map to methods, for example, that implement the operators that these names represent. By way of example, a user can specify a query in a form such as “from n in numbers where n<10 select n,” wherein “numbers” is a data source and the query returns integers from the data source that are less than ten. Further, query operators can be combined in various ways to generate queries of arbitrary complexity.

Query operators can create and operate over monads. A monad is a type of abstract data type constructor used to represent computations rather than data. Furthermore, monad actions to be chained together to build a pipeline or set of data processing elements defined in series, wherein each action includes processing rules provided by the monad. More formally, a monad implements two operations, namely return and bind. Return takes a value of a particular type and deposits it into a container with a monadic type (e.g. T->M<T>). Bind extracts the original value from the container and provides the value to the next function in the pipeline (e.g., M<T>->(T->M<R>)->M<R>). It is the bind operation that enables compositionality of functions, or in this context, query operators.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to monadic type preservation for query operators. Query operators can be generated or altered to return monadic types rather than or in addition to non-monadic types. Query operators that are defined over a monad and suitable to return non-monadic single-value types, such as aggregate query operators, can prevent further composition based on their result. New or altered versions of such operators can be constructed to return monadic types and thus enable further composition with operators defined over a particular monad, among other things. Furthermore, such query operators can also be designed to be lazy and/or asynchronous.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an aggregate query operator.

FIG. 2 is a block diagram of a decomposition query operator.

FIG. 3 is a graphical illustration of monad interaction.

FIG. 4A is a graphical illustration of interaction with an IEnumerable monad.

FIG. 4B is a graphical illustration of interaction with an IObservable monad.

FIG. 5 is a block diagram of a query system.

FIG. 6 is an illustration of remote versus local execution of aggregate query operators with cancellation behavior.

FIG. 7 is a flow chart diagram of a method of querying data.

FIG. 8 is a flow chart diagram of method of querying data.

FIG. 9 is a flow chart diagram of a method of facilitating remoting of query operators.

FIG. 10 is a flow chart diagram of a method of executing query operators.

FIG. 11 is a schematic block diagram illustrating a suitable operating environment for aspects of the subject disclosure.

### DETAILED DESCRIPTION

Details below are generally directed toward preserving monadic types for query operators. While some query operators seem to have a single element nature, leaving the confines of a monadic type approach to queryable sequences prevents further composition, among other things. Aggregates, such as the computation of a sum, are notable samples of where a transition is made from a sequence of numbers into a scalar value (e.g. scalar return type). Consequently, no other operations can be specified on the result, hindering the ability to carry out operations or remote complex queries. By preserving the monadic type in the return position of such query operators, further composition can be enabled using operators defined over that monad. Additionally, such query operators can be constructed to execute lazily and/or asynchronously, and a data representation (e.g., expression tree) can retain user intent and not trigger immediate (e.g., eager and/or synchronous) execution. These properties can be related to a monad, and hence preservation of the monad allows a form of composition that retains such desired properties. For instance, with respect to the IObservable<T> monad, asynchrony is an essential property and maintaining asynchrony for aggregation operators, for example, is desirable.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

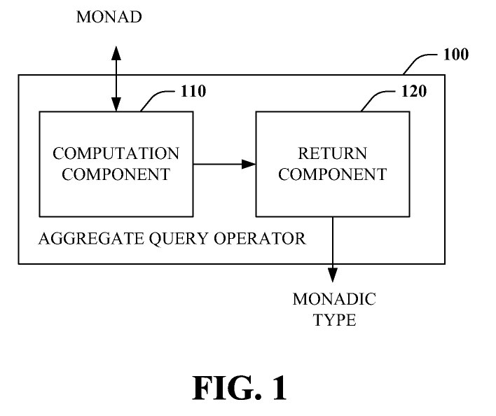

Referring initially to FIG. 1, illustrated is an aggregate query operator 100 (which can be a component as defined herein e.g., aggregate query operator component). A query operator corresponds to a method, among other primitive constructs, that supports language-integrated queries, or stated differently, a convenient and declarative shorthand query syntax that facilitates specification of queries within a programming language. The aggregate query operator 100 represents a query operator that is suitable to, or in other words, that lends itself to, returning a non-monadic type. For example, query operators including but are not limited to “Sum,” “Min,” “Max,” “Count,” and “Average” lend themselves to returning a single-value result type rather than a monadic type. Going forward, for purposes of clarity and brevity, this detailed description and associated figures will focus on the aggregation operators as notable examples of query operators of concern. However, the claimed subject matter is not limited thereto as other types of operators can exhibit similar properties including but not limited to decomposition operators such as “First” and “Last.”

When a query operator returns a non-monadic type, or in other words, leaves a monad, further composition using operators defined on the monad cannot occur. This has many significant implications. First, a particular query (e.g., performing multiple aggregates at once) may be harder to express. Second, such operators could trigger a query to execute too eagerly, which can be particularly problematic with respect to remoting a query (communicating the query across application domain boundaries). Further, data binding frameworks that rely on a sequence rather than a scalar value will no longer work.

To address these issues and provide further benefits, the aggregate query operator 100 is provided. As shown, the aggregate query operator 100 (also a component as that term is defined herein) includes a computation component 110 and a return component 120. The computation component 110 is configured to execute a computation over a sequence monad, wherein the computation can correspond to an aggregation operation such as “Sum,” “Min,”, “Max,” “Count,” or “Average.” The return component 120 is configured to return the result of the computation as a monadic type.

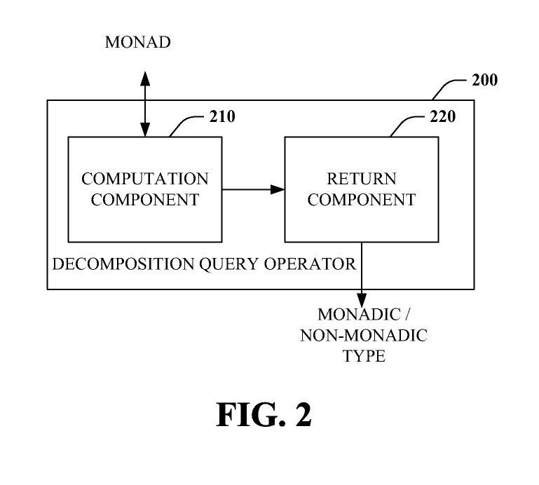

Turning to FIG. 2, a decomposition query operator 200 (which can be a component as defined herein) is depicted. The decomposition query operator 200 includes a computation component 210 and a return component 220. The computation component 210 is configured to perform a computation corresponding to a decomposition operation, such as but not limited to “First” and “Last,” over a sequence monad, wherein “First” retrieves the first element of a sequence, and “Last” retrieves the last element of a sequence. The return component 220 is configured to return the result of the computation. In accordance with one embodiment, the return component 220 can produce a non-monadic type to provide a mechanism to escape the monad. Additionally, in another form of the decomposition query operator 200, for example, corresponding to “TakeFirst” and “TakeLast,” the return component 220 can emit a monadic type (e.g., original or different (converted) type). In this manner, functionality provided by a decomposition query operator 200 can be composed with other query operators available over the monad.

In addition to furthering composability, additional benefits can be associated with query operators returning monadic types. For instance, the query operators can support lazy execution rather than eager execution, wherein lazy execution refers to delayed execution of a computation until a result is required, and eager execution refers to the opposite of lazy execution in which execution occurs as soon as it is able to be performed (e.g., when a computation is bound to a variable). As will be discussed further hereinafter, this is helpful with respect to remoting queries. Furthermore, note that the query operators can also support asynchronous as opposed to synchronous execution.

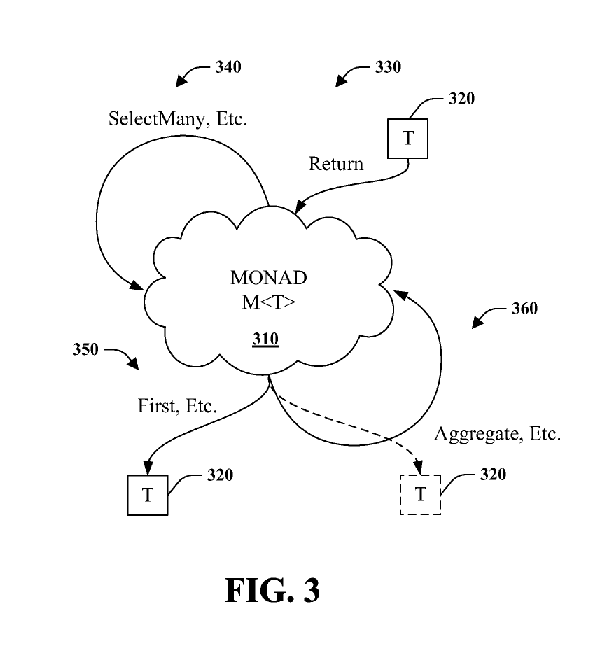

FIG. 3 is a graphical illustration of monad interaction to facilitate clarity and understanding with respect to the aspects of the disclosure. A monad “M<T>” 310 is depicted with various instances of elements of non-monadic type “T” 320. A return 330 represents anamorphism in which an element of non-monadic type “T>” 320 is converted to a monadic type or monad “M<T>” 310. “SelectMany” 340 corresponds to a bind in which the original value from a monad container “T” is extracted and the value is provided to the next function in a pipeline (e.g., M<T>->(T->M<R>)->M<R>). In other words, the “SelectMany” 340 corresponds to an operation that stays within the context of the monad 310. “First” 350 represents decomposition query operators that exit the monad 310 and emits an element type “T” 320. Aggregation 360 represents execution of an aggregation operation. As shown in dashed lines, conventionally, aggregation 360 would result in production of an element outside the monad 310, namely of a non-monadic type “T” 320. However, as described above, aggregation query operators can remain within the monad 310 by producing monadic type.

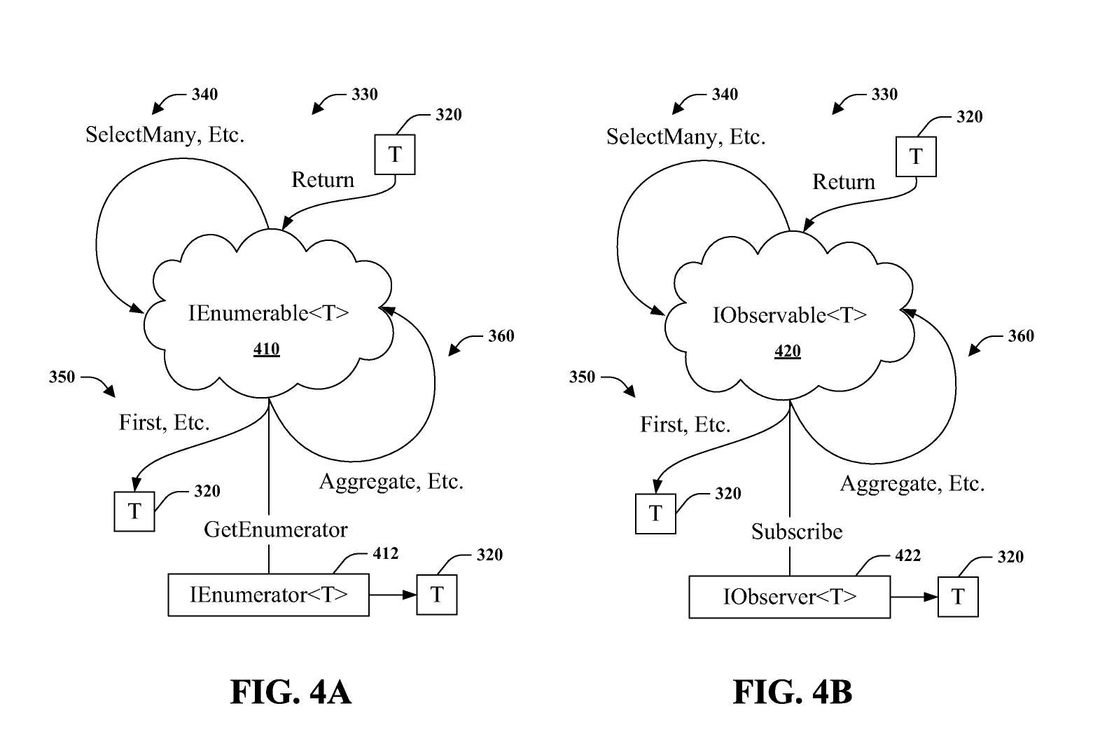

FIGS. 4A and B provide a graphical illustration of two exemplary sequence monads that can be created at least in part by and/or used by query operators described herein. Of course, the claimed subject matter is not limited to the exemplary sequence monads. Rather, the exemplary sequence monads are only two of many different monads that can be employed with respect to aspects of the disclosure described herein. Furthermore, FIGS. 4A and B also include interactions described and depicted with respect to FIG. 3 and as such include the same reference numerals.

FIG. 4A depicts “IEnumerable<T>” 410, which is one exemplary instance of a sequence monad that can be created and/or employed by query operators. “IEnumerable<T>” 410 represents computations for iterating over pull-based data (e.g., in-memory arrays). In particular, the “IEnumerable<T>” 410 exposes “IEnumerator<T>” 412 that can be employed to get an element from the sequence monad “IEnumerable<T>” 410 and produce the element outside the monad “IEnumerable<T>” 410 or in other words produce an element with a non-monadic type “T” 320.

FIG. 4B illustrates “IObservable<T>” 420, which is an exemplary instance of a sequence monad that can created and/or employed by query operators. “IObservable<T>” 420 represents computations for iterating over push-based data (e.g., events, asynchronous computations . . . ). More particularly, “IObservable<T>” 420 exposes “IObserver<T>” 422 that can be supplied to “IObservable<T>” 420 during subscription in order to receive notification regarding new or updated data, among other things. Furthermore, pushed data elements exit the monad “IObservable<T>” 420. Stated differently, pushed data elements are provided with a non-monadic type “T.”

As described previously with respect to the monad 310 of FIG. 3, exemplary sequence monads “IEnumerable<T>” 410 and “IObservable<T>” 420 of FIGS. 4A and B, respectively, can allow four different interactions, namely return 330, “SelectMany” 340 (Bind), “First” 350 and “Aggregation” 360. Return 330 constructs a monad from a non-monadic type “T,” and both “SelectMany” 340 and “Aggregation” 360 maintain monadic types. “First” 350, representing decomposition operations, is the sole operator that escapes the sequence monads “IEnumerable<T>” 410 and “IObservable<T>” 420, thereby furthering compositionality.

The world of observable sequences (e.g., IObservable<T>, IObserver<T>) provides some advantages over the world enumerable sequences (e.g., IEnumerable<T>, IEnumerator<T>). For example, the synchronous invocation nature of query operators is remedied by the asynchronous nature of “IObservable<T>” and “IObserver<T>” interfaces. In particular, one can subscribe to a query expression's results, which causes an asynchronous rendezvous to a registered observer as data becomes available. Additionally, computations can be cancelled, as described further below.

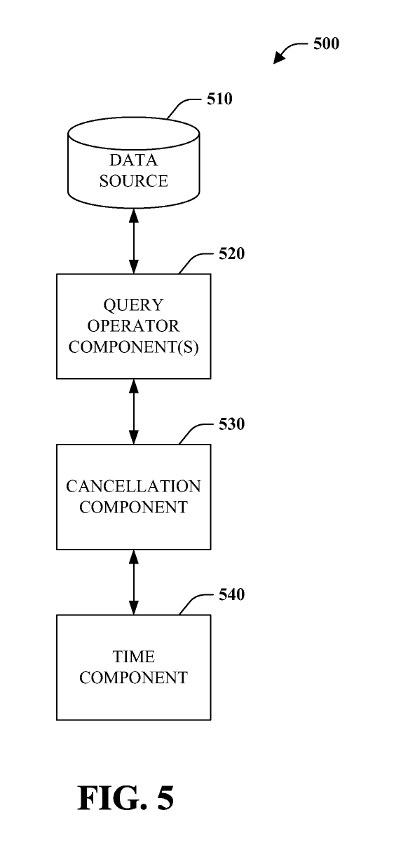

FIG. 5 is a block diagram of a query system 500, which includes a data source 510, one or more query operator components 520, a cancellation component 530, and a time component 540. The one or more query operator components 520 can correspond to a single query operator or a composition of query operators forming, what can also be referred to as, a query expression. In accordance with one embodiment, at least one of the query operator components 520 can be an aggregation query operator or the like. The one or more query operator components 520 can seek to acquire particular data from the data source 510. The cancellation component 530 can at least initiate cancellation of a computation. In other words, the cancellation component 530 can terminate query execution (if supported by a provider). The time component 540 can keep track of time and notify the cancellation component 530 to cancel execution of at least one of the one or more query operator components 520 after a particular period of time. In one implementation, the time component 540 can be implemented as at least one time-based operator component such as a timeout operator that takes a time and initiates some action after that time. Both the cancellation component 530 and the time component 540 can be quite useful in an asynchronous context where for some reason a response is taking longer to return than is desirable. For example, after a given time, a subscription to a push-based data source can be disposed.

Where queries are represented as data rather than code for example in accordance with an IQueryable or IQbservable interfaces one additional benefit to using monadic type preserving operators is the ability to remote aggregation query operators to a query provider for translation to another form (e.g., SQL, XML . . . ) or other purposes (e.g., optimization). The following code fragment illustrates how aggregation query operators can be defined to provide a data representation such as an expression tree:

```
static class Qbservable
{
  public static T Max<T>(this IQbservable<T> source)
  {
  return source.Provider.CreateQuery<T>(
    Expression.Call(
  ((MethodInfo)MethodInfo.GetCurrentMethod( )).MakeGenericMethod
  (new[ ] {
  typeof (T) }),
    source.Expression
    )
  );
}
```

By using this technique, a query provider will be able to view a data representation of the “Max” operation such that the whole operation can be remoted, for example. By contrast, observe how this differs from a conventional pull-based IQueryable <T> interface with aggregation operations defined in terms of a call to a provider's “ExecuteQuery” method:

static class Queryable
{

public static int Max(this IQueryable<int> source)
{

return source.Provider.ExecuteQuery<int>(

Expression.Call(

(MethodInfo)MethodInfo.GetCurrentMethod( ),
source.Expression

)

);

}

}

This method leaves the monad through the synchronous “ExecuteQuery” method. While the query provider still sees the method call representing the user's intent to compute the maximum, further composition based on this result is blocked. In particular, it is not possible to remote computations based on various similar query operators. Consider, for example, the following code snippet:

IQueryable<decimal> prices = products.Select(p => p.Price);
int count = prices.Count( );
decimal sum = prices.Sum( );

Here, performing a division between the values for “sum” and “count” to compute an average will happen “client-side” rather than being inspectable for a provider to translate into a target domain. While in this particular case an “Average” operator can be used, in the general case, such complex calculations are broken. With monad preserving query operator definitions, such as the one provided with respect to the IQbservable interface above, a user could specify:

IQbservable<decimal> prices = products.Select(p => p.Price);
// Assume the source sequence is observable this time
IQbservable<int> count = prices.Count( );
IQbservable<decimal> sum = prices.Sum( );
IQbservable<decimal> averagePrice = count.ForkJoin(sum, (c, s) => s /
c);

In this particular computation the “ForkJoin” operator is used to observe both sequences and combine the result values produced by both using a selector function. Alternatively, the subscription to prices can be shared across both aggregation operator uses as follows:

IQbservable<decimal> averagePrice = prices.Publish(prc =>
prc.Sum( ).ForkJoin(prc.Count( ), (sum, count) => sum / count));

Either way what is returned is a sequence that stays in the “IQbservable” monad, which is evaluated lazily since computation will not begin until a subscription occurs. While computation is in progress, there is still an option to cancel the subscription, effectively stopping the computation (if the provider chooses to respond to such an un-subscription action). If one wants to get a single value out in a synchronous manner, local observable operators like “First,” “Last,” and “Single” can be used. If asynchronous behavior is desired for reasons of cancellation and also further composition, a “Subscribe” operation with an “OnNext” handler can be used, for example:

IDisposable cancel = averagePrice.Subscribe(result =>
Console.WriteLine(“Average price: $“ + result));

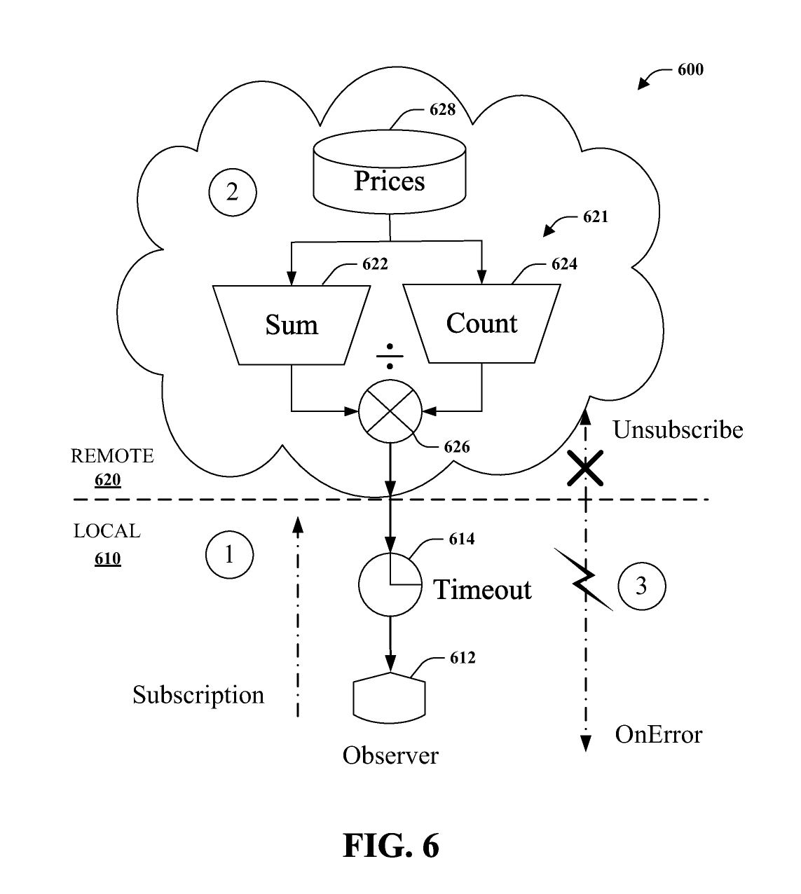

FIG. 6 illustrates remote versus local execution of aggregate query operators with cancellation behavior. The dashed horizontal line identifies the difference between local execution environment 610 and remote execution environment 620. For example, a plurality of operators could have been specified and transformed into a data representation in the local execution environment 610 that are subsequently translated and transmitted to the remote execution environment 620. Here, a query expression 621 is illustrated including a sum operator 622, a count operator 624, and a ForkJoin operator 626, which operates over push-based, or in other words, observable, data source 628 (“Prices”). The local execution environment 610 includes an observer component 612 and a timeout component 614. The observer component 612 observers or receives notification regarding data including the result of the query expression 621. The timeout component 614 is configured to initiate cancellation of a computation after a predetermined period of time.

Notice that the timeout component 614 could have formed part of a the query expression 621 without leaving the monad, for example:

var averagePriceWithTimeout =
averagePrice.Timeout(TimeSpan.FromSeconds(30));

If a query provider does not support translation of such an operation to the target domain, for example because there is no corresponding concept in the query language being targeted, one can still compose such an operation onto the source sequence by using the “AsObservable” method, for instance:

var averagePriceWithTimeout =
averagePrice.AsObservable( ).Timeout(TimeSpan.FromSeconds(30));

Now the timeout is maintained locally (e.g., on a client), as shown, in FIG. 6.

To start computation, the observer component 612 provides a subscription to the data source 628 across the local/remote boundary. This can also trigger a query provider to carry out a translation of the query expression 621, which is sent to the server. At this point, the remote execution environment 620 has established a kind of feedback channel to the local execution environment 610. Next, the remote computation is started. Parallel computation of the sum and count aggregates can be performed ultimately being joined by the ForkJoin operator 626, which is still available over the partial aggregation results due to the preservation of the monadic observable sequence type. A local timer is started by the timeout component 614 upon subscription. If the timer fires (indicating a timeout), two actions occur. The observer component 612 is notified by means of an “OnError” message signaling that the timeout happened. At substantially the same time, the remote subscription can be disposed, which can cause the remote execution environment 620 to terminate the running computation. It is up to a query provider to either supply or not supply this service. Nevertheless, it does not make any difference to the local execution environment 610. Since the subscription was cancelled, the local execution environment 610 will not be notified of about any “leftover” or “pending” incoming messages.

It is to be noted in accordance with one aspect of the disclosure that aggregate query operations need not be single valued. Rather, aggregate query operations can represent running computations. Such running computations are more powerful than single-valued computations since they provide more data that could be of use. Further, progress could be observed periodically (e.g., using an operator like “Do”). Additionally, the last value of an aggregation (e.g., the aggregation result) can be obtained by using operators such as “Last” that leaves the monad or “TakeLast” that does not leave the monad.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, one or more query operator components could employ such mechanism to provide intelligent computations.

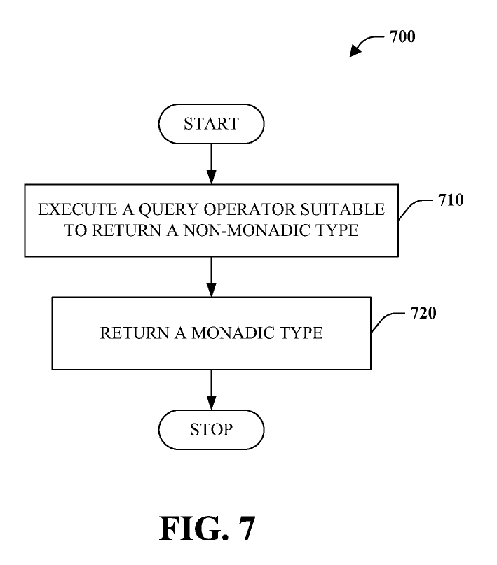

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, a method of querying data 700 is depicted. At reference numeral 710, a query operator defined over a sequence monad and suitable to return a single-value type is executed. At numeral 720, a monadic type is returned as a result of the execution. In this manner, the query operator preserves the monadic type, which can allow for further composition that would not be possible if a single-value type was returned, which exits the confines of a monad. In one example, the query operators can pertain to aggregates defined over a sequence monad such as “IEnumerable” or “IObservable.” Of course, other query operators with similar properties can also be executed and return a monad type including without limitation decomposition operators such as but not limited to “First,” “Last,” “Single,” “Run,” and “Subscribe.” Overall, compositionality is extended by reducing the number of ways of leaving a monad.

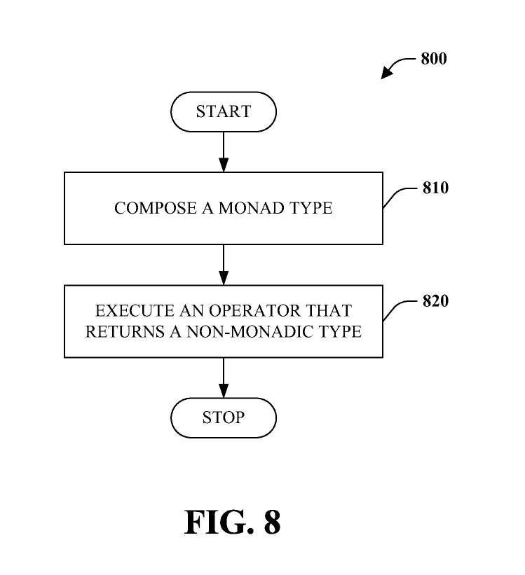

FIG. 8 is a flow chart diagram of a method of querying data 800. At reference numeral 810, an instance of a monad type is composed or otherwise identified. At reference numeral 820, a query operator that employs or otherwise operates over the monad type is executed and returns a non-monadic type. Here, a query operator leaves the monad and thus no other operations can be specified on the result. In one embodiment, the query operators that function in this matter are the decomposition operators such as “First,” “Last,” and “Take” among others. However, it is also to be appreciated that lazy, asynchronous, and/or type-preserving variants of such operators can be constructed to facilitate compositionality. For example, a “TakeLast(n)” decomposition query operator can be produced in accordance with an aspect of this disclosure that is lazy, asynchronous, and/or type-preserving and generalized to yield a tail of any length “n.”

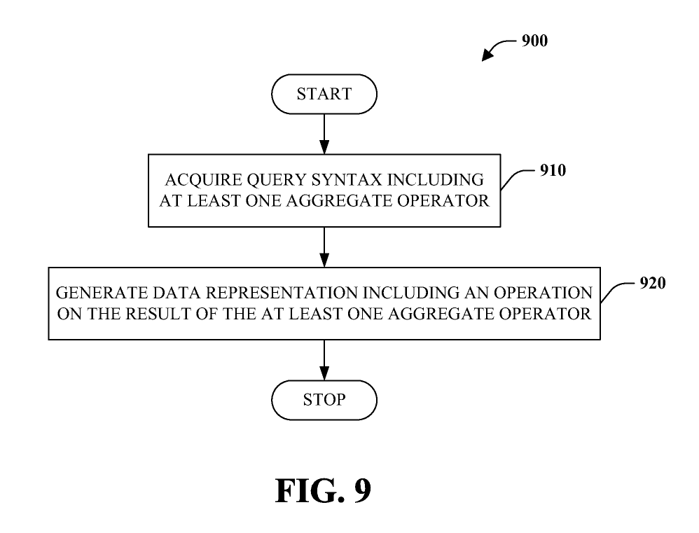

FIG. 9 illustrates a method of facilitating remoting of query operators 900. At reference numeral 910, a query syntax including at least one aggregate query operator is received, retrieved, or otherwise obtained or acquired. At numeral 920, a data representation is generated that captures the query specified by the syntax including the at least one aggregation query operator. More specifically, the data representation can include an operation on the result of the at least one aggregate query operator. Conventional aggregate query operators leave the monad over which they operate. According to an aspect of this disclosure, additional or replacement aggregate operators can be produced that that are lazy and maintain a monadic type (e.g., AggregateLazy, SumLazy, MinLazy, MaxLazy . . . ).

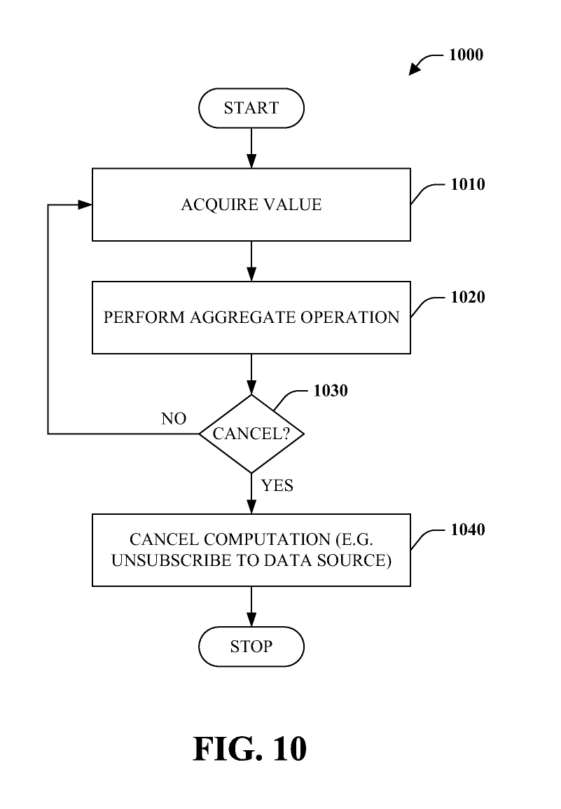

FIG. 10 is a flow chart diagram of a method executing query operators 1000. At reference numeral 1010, a value is received or retrieved from a data source. At numeral 1020, an aggregation operation is performed utilizing the newly acquired value. For example, the value can be utilized to compute an average. At reference numeral 1030, a determination is made regarding whether or not to cancel the computation. For example, after a predetermined time, if an expected result has not been received then cancellation may be appropriate. If it is determined that computation is to be cancelled at reference numeral 1030 (“YES”), then the method proceeds to numeral 1040 where the computation is cancelled at least in effect, for example by unsubscribing to a data source. If at reference numeral 1030 it is determined that the computation is not to be cancelled (“NO”), then the method loops back to reference numeral 1010 where another value can be acquired. Note that the computation described here can pertain to a running aggregate operator over a sequence of data rather than a single value.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

As used herein, the verb forms of the word “remote” such as but not limited to “remoting,” “remoted,” and “remotes” are intended to refer to transmission of code or data across application domains that isolate software applications physically and/or logically so they do not affect each other. After remoting, the subject of the remoting (e.g., code or data) can reside on the same computer on which they originated or a different network connected computer, for example.

The term “query expression” as used herein refers to a syntax for specifying a query, which includes one or more query operators that map to underlying language primitive implementations such as methods by the same name.

The word “lazy” or various forms thereof as used herein is intended to refer to delaying execution or evaluation of a computation until a result is required. By contrast, “eager” or “greedy” evaluation or execution occurs as soon as a computation is bound to a variable. Herein, various query operators can be lazy. In other words, execution of such query operators can be delayed until a result is required, for example upon subscription to a data source. Among other things, lazy evaluation facilitates compositionality and generation of a data representation that can later be translated and executed by another machine, for instance.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

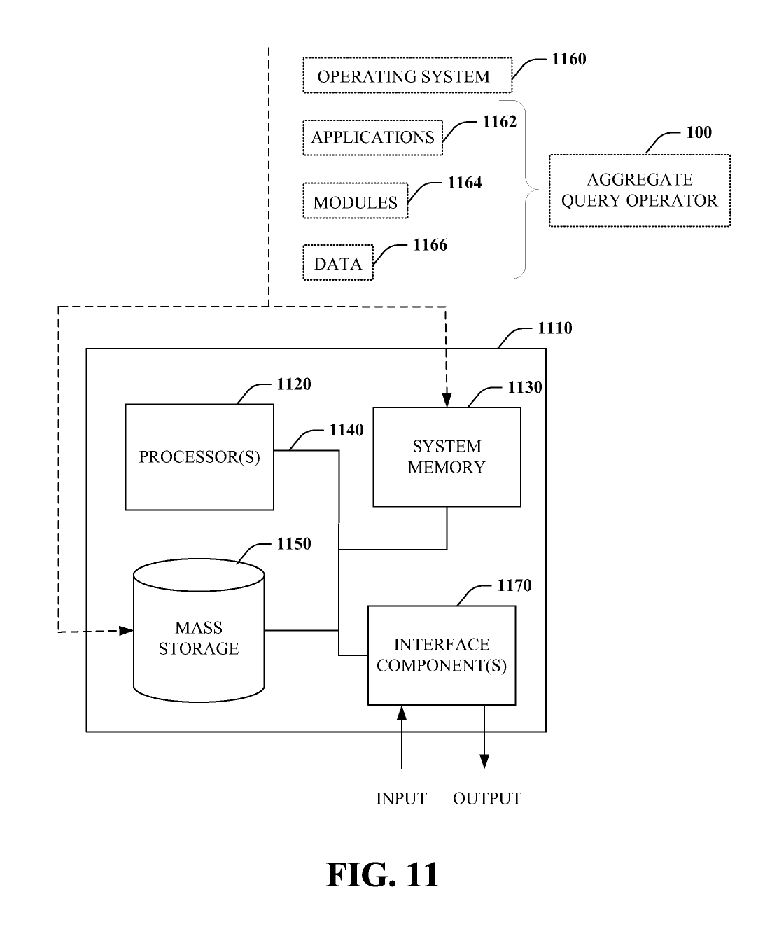

In order to provide a context for the claimed subject matter, FIG. 11 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 11, illustrated is an example computer 1110 or computing device (e.g., desktop, laptop, server, hand-held, programmable consumer or industrial electronics, set-top box, game system . . . ). The computer 1110 includes one or more processor(s) 1120, system memory 1130, system bus 1140, mass storage 1150, and one or more interface components 1170. The system bus 1140 communicatively couples at least the above system components. However, it is to be appreciated that in its simplest form the computer 1110 can include one or more processors 1120 coupled to system memory 1130 that execute various computer executable actions, instructions, and or components.

The processor(s) 1120 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1120 may also be implemented as a combination of computing devices, for example a combination of a DSP and a microprocessor, a plurality of microprocessors, multi-core processors, one or more microprocessors in conjunction with a DSP core, or any other such configuration.

The computer 1110 can include or otherwise interact with a variety of computer-readable media to facilitate control of the computer 1110 to implement one or more aspects of the claimed subject matter. The computer-readable media can be any available media that can be accessed by the computer 1110 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

System memory 1130 and mass storage 1150 are examples of computer-readable storage media. Depending on the exact configuration and type of computing device, system memory 1130 may be volatile (e.g., RAM), non-volatile (e.g., ROM, flash memory . . . ) or some combination of the two. By way of example, the basic input/output system (BIOS), including basic routines to transfer information between elements within the computer 1110, such as during start-up, can be stored in nonvolatile memory, while volatile memory can act as external cache memory to facilitate processing by the processor(s) 1120, among other things.

Mass storage 1150 includes removable/non-removable, volatile/non-volatile computer storage media for storage of large amounts of data relative to the system memory 1130. For example, mass storage 1150 includes, but is not limited to, one or more devices such as a magnetic or optical disk drive, floppy disk drive, flash memory, solid-state drive, or memory stick.

System memory 1130 and mass storage 1150 can include, or have stored therein, operating system 1160, one or more applications 1162, one or more program modules 1164, and data 1166. The operating system 1160 acts to control and allocate resources of the computer 1110. Applications 1162 include one or both of system and application software and can exploit management of resources by the operating system 1160 through program modules 1164 and data 1166 stored in system memory 1130 and/or mass storage 1150 to perform one or more actions. Accordingly, applications 1162 can turn a general-purpose computer 1110 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the aggregate query operator 100, or operators with like properties that return monadic types, can be part of an application 1162, and include one or more modules 1164 and data 1166 stored in memory and/or mass storage 1150 whose functionality can be realized when executed by one or more processor(s) 1120, as shown.

The computer 1110 also includes one or more interface components 1170 that are communicatively coupled to the system bus 1140 and facilitate interaction with the computer 1110. By way of example, the interface component 1170 can be a port (e.g., serial, parallel, PCMCIA, USB, FireWire . . . ) or an interface card (e.g., sound, video . . . ) or the like. In one example implementation, the interface component 1170 can be embodied as a user input/output interface to enable a user to enter commands and information into the computer 1110 through one or more input devices (e.g., pointing device such as a mouse, trackball, stylus, touch pad, keyboard, microphone, joystick, game pad, satellite dish, scanner, camera, other computer . . . ).

In another example implementation, the interface component 1170 can be embodied as an output peripheral interface to supply output to displays (e.g., CRT, LCD, plasma . . . ), speakers, printers, and/or other computers, among other things. Still further yet, the interface component 1170 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of querying data, comprising:
employing at least one processor configured to execute computer-executable instructions stored in memory to perform the following acts:
executing a query operator defined over a sequence monad and suitable to return a single-value type; and
returning a monadic type.

2. The method of claim 1, further comprising executing an aggregate query operator.

3. The method of claim 2, further comprising executing the aggregate query operator lazily.

4. The method of claim 2, executing the aggregate query operator comprises computing a running aggregate.

5. The method of claim 1, further comprising executing a decomposition query operator that returns a non-monadic type.

6. The method of claim 1, further comprising executing the query operator asynchronously.

7. The method of claim 1, further comprising cancelling execution of the query operator.

8. The method of claim 7, further comprising cancelling execution of the query operator after a predetermined period of time.

9. A query system, comprising:
a processor coupled to a memory, the processor configured to execute the following computer-executable components stored in the memory:
an aggregate query operator component defined over a sequence monad and configured to return a monadic type.

10. The system of claim 9, the aggregate query operator component is configured as a lazy operator.

11. The system of claim 9, the aggregate query operator component is defined over a remote sequence monad.

12. The system of claim 11, further comprising a time-based operator component configured to halt execution of a query specified with the aggregate query operator component.

13. The system of claim 12, wherein the time-based operator is executed in a first execution environment and the aggregate query operator is executed in a second execution environment.

14. The system of claim 9, the aggregate query operator component is configured to perform a running computation.

15. The system of claim 9, further comprises a decomposition query-operator component defined over the sequence monad and configured with a non-monadic return type.

16. The system of claim 9, further comprising a decomposition query operator component configured with a monadic return type.

17. A computer-readable medium having instructions stored thereon that enables at least one processor to perform the following acts:
executing an aggregate query operator defined over a sequence monad; and
returning a monadic type.

18. The computer-readable medium of claim 17, further comprising executing the aggregate query operator asynchronously.

19. The computer-readable medium of claim 17, further comprising executing a decomposition query operator that returns a non-monadic type.

20. The computer-readable medium of claim 17, further comprising executing a decomposition query operator that returns a monadic type.
